(19) United States
(12) Patent Application Publication
(10) Pub. No.: US 2007/0116258 A1
(43) Pub. Date: May 24, 2007

(54) Switch module for computer service line

(76) Inventor: Danny DeCosmo, Suffield, CT (US)

Correspondence Address: ALIX YALE & RISTAS LLP, 750 MAIN STREET, SUITE 1400, HARTFORD, CT, 06103, US

(21) Appl. No.: 11/248,516

(22) Filed: Oct. 12, 2005

(51) Int. Cl. H04M 1/00; H04M 9/00

(52) U.S. Cl. 379/413.03

(57) ABSTRACT

A switch module is adapted for mounting to the side of a computer. The module includes a switch for controlling the service line communication with a computer. The module may have a regular octagon shape wherein the switch and a pair of terminals are located on diametrically opposite sides.

### BACKGROUND OF THE INVENTION

This invention relates generally to devices for controlling access to service lines such as cable, DSL and various Internet service lines. More particularly, this invention relates to a switch device for manually terminating service to a computer.

The full usage and enjoyment of personal computers has been directly related to the connection to the Internet by various service providers which provide for fast access to the Internet as well as for email service. The benefits of the various services, however, are tempered by annoyances such as spam, numerous bombardments of advertisements and undesirable messages as well as infection with computer viruses. Many personal computer users now desire to operate or place the computer in a stand-alone, isolated environment for extended periods of time to act as a buffer or shield against some of the undesirable attributes of continuous 24 hour service line connections. In many respects, the manufacturers of personal computers have not provided an easily operable device to manually control connection of the DSL cable or service provider line to the personal computer.

### SUMMARY OF THE INVENTION

Briefly stated, the invention in a preferred form is a switch module for controlling communication between a service line and a computer. The module comprises a housing having a front and a back and multiple sides extending between the front and the back. A pair of service line terminals is disposed at one side. A bistable switch having an actuator is disposed at a second side. A communication circuit disposed in the housing extends from certain pins of the terminals to the switch. When the actuator of the switch is in a first position, the service line signal communicates between the terminals. When the actuator is in a second position, the signal communication between the terminals is interrupted, and accordingly service to the computer is terminated.

The terminals may be socket connectors. A double sided adhesive member may be employed to attach the module to the side of the computer. The module housing is preferably in the shape of an octagon wherein the switch and the terminals are located at diametrically opposite sides of the housing. The communication circuit is preferably defined on a circuit board and the switch and the terminals are mounted to the circuit board.

An object of the invention is to provide a new and improved switch module which can be easily incorporated for use with a personal computer to manually control the connection of the service line to the computer.

Another object of the invention is to provide a new and improved switch module which may be efficiently installed for use with a personal computer.

A further object of the invention is to provide a new and improved switch module having an efficient and low cost construction and which is visually prominent and is easily operable to terminate the service line connection to a personal computer as desired and wherein the service line may be reconnected without re-booting the computer.

Other objects and advantages of the invention will become apparent from the drawings and the detailed description.

### BRIEF DESCRIPTION OF THE DRAWINGS

FIG. 1 is a perspective view of a preferred embodiment of a switch module in accordance with the present invention;

FIG. 2 is a perspective view of the switch module of FIG. 1 taken from an opposite side thereof;

FIG. 3 is a rear view of the switch module of FIG. 1, portions being shown in broken lines;

FIG. 4 is a schematic view illustrating the switch module in relation to the associated computer and a representative service line;

FIG. 5 is a perspective view of a housing section for the switch module of FIG. 1;

FIG. 6 is a perspective view of a top housing section for the switch module of FIG. 1;

FIG. 7 is a top plan view of a control board employed in the switch module of FIG. 1; and

FIG. 8 is a perspective view of a control board assembly for the switch module of FIG. 1.

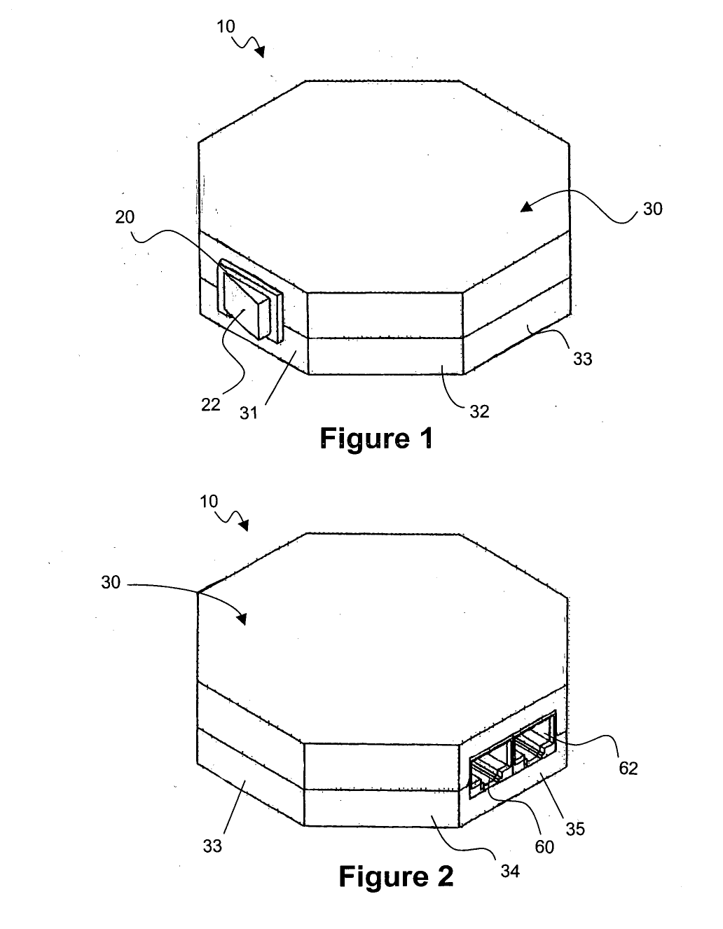

### DETAILED DESCRIPTION OF THE PREFERRED EMBODIMENT

With reference to the drawings, wherein like numerals represent like parts throughout the figures, a switch module in accordance with the present invention is generally designated by the numeral 10. With additional reference to the FIG. 4, the switch module 10 is adapted for mounting to the side of a computer 12 for terminating the connection with the computer service line 14 which may be a cable, DSL or other service line. An auxiliary cable 16 connects to provide communication between the module 10 and the service port 18 of the computer. The switch module 10 includes a bistable switch 20 with an actuator 22 which is manually operable so that in a first position, the service line 14 connects via cable 16 with the service line port 18 of the personal computer, and in a second position, communication between the service line and the computer port is terminated. The service line may be reconnected in approximately 5 seconds without requiring that the computer be re-booted.

In a preferred embodiment, the switch module includes a rigid housing 30 having a regular octagonal form with sides 31-38 of equal dimensions. The housing 30 is formed by mating top (front) and bottom (back) sections 40 and 50 which are preferably molded plastic components joined to provide the finished housing. Each of the sections include mating rectangular openings 42, 52, 44 and 54, which receive, respectively, the switch 20 at one side 31 and provide access to a pair of cable socket terminals 60 and 62 at the opposing side 35. The sections are further secured by means of projecting cylindrical bosses 56 and receptacles 46 which form an interference fit for securing the sections together. The sections may also have a complementary peripheral lip 45 and recess 55 to facilitate the joining. The section may also have ribs 47 to reinforce the sides.

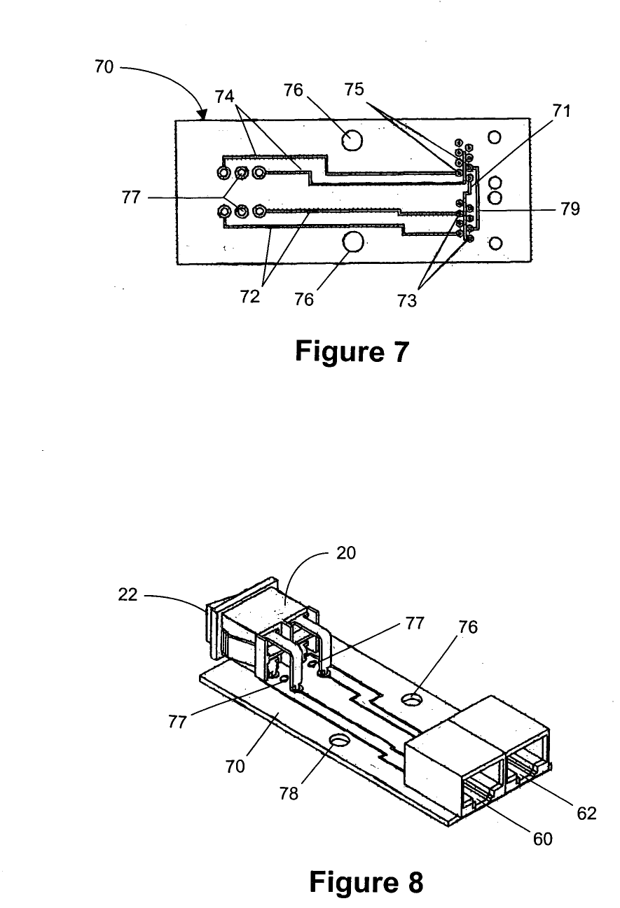

With reference to FIGS. 7 and 8, a circuit board 70 has pairs of printed lines 72 and 74 which lead from terminal positive pin sockets 73 and 75 at one end of the board to the other end. The switch 20, which in one embodiment is a double pole, single throw rocker switch Model No. RPD2KKGL00716 of Light County, Inc. of Taiwan, is mounted to an upper end of the board and electrically communicates with the lines. The circuit board may have openings 77 to accommodate alternative switch configurations. The terminal sockets 60 and 62 are mounted at the other end of the board and electrically communicate with the lines 72 and 74. The connection between two positive pins of each terminal is selectively connected or interrupted by the circuit/switch circuitry. The other useful negative terminal pins are correspondingly directly connected by lines 71 and 79 the printed circuit. The circuit board includes a pair of opposed apertures 76 which are centrally located and offset to provide a mounting point for the circuit board. The bottom section includes cylindrical platforms 48 Which project from the surface to provide a support for the circuit board. A pair of locating nipples 49 protruding from the middle platforms are closely received in the apertures 76 of the circuit board to secure the circuit board in the proper position.

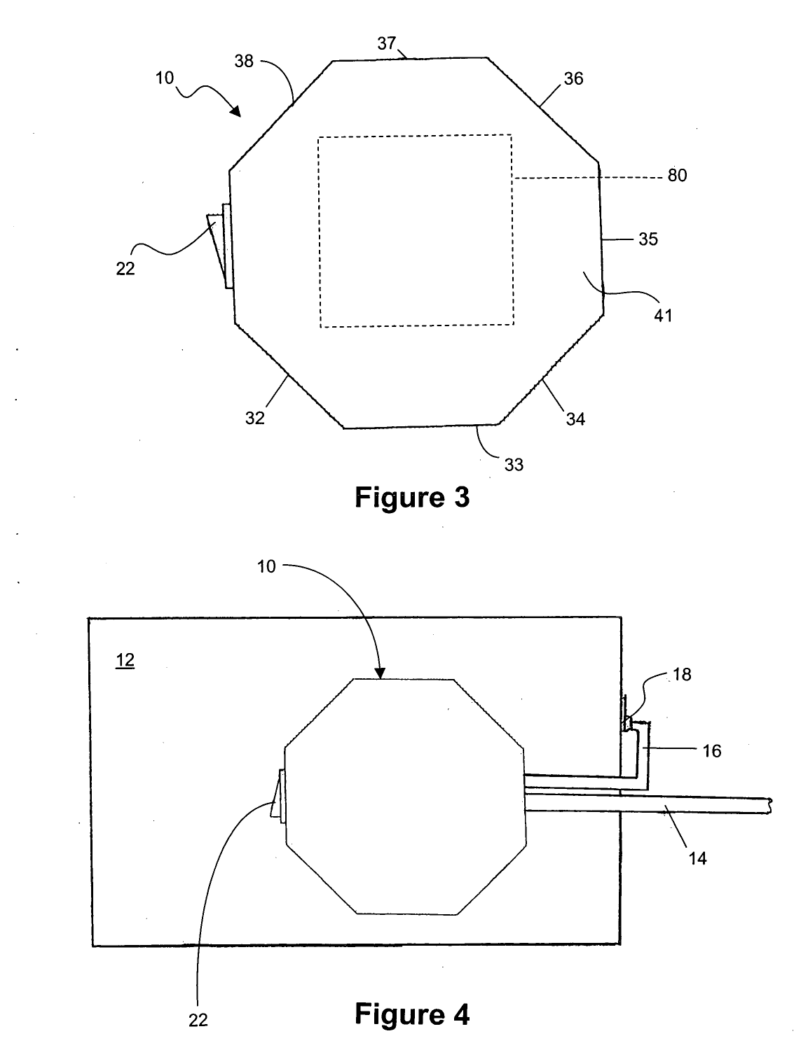

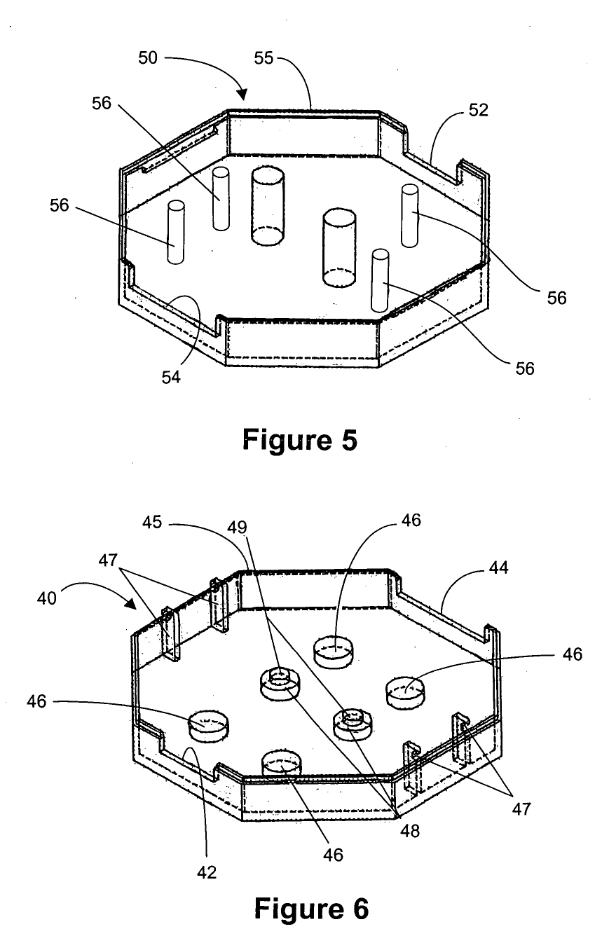

When the switch module 10 is fully assembled, a rectangular double-sided adhesive pad 80 may be applied to the exterior of the back or bottom surface 41 (FIG. 3). For installation purposes, the outer cover of the adhesive pad is removed to expose the adhesive surface and the switch module is fixed to a side or panel of the computer.

Other connecting materials may also be employed. A short auxiliary cable 16 is received in the terminal socket 62 and connects with the service port 18 of the computer. The service end of the service line 14 is then received in the other socket terminal 60. It should be appreciated that the switch actuator may be manually activated to either provide service communication with the computer 12 or in a second position to terminate the service communication.

In one preferred embodiment, the housing 30 is in the shape of a stop sign and has a red tint to strikingly visually suggest the function of stopping the service communication with the computer. It should, however, also be appreciated that other forms of the housing may be provided.

While the foregoing description has been set forth for purposes of illustration of the invention, various modifications, adaptations and alternatives may occur to one skilled in the art without departing from the spirit and the scope of the present invention.

What is claimed:

1. A switch module for controlling a service line communication to a computer comprising:
a housing having a front and a back and multiple sides extending therebetween;
a pair of service line terminals disposed at one side;
a bistable switch having an actuator disposed at a second side; and
a communication circuit disposed in said housing and connecting from said terminals to said switch, wherein when said actuator is in a first position, a signal communicates between said terminals and when said actuator is in a second position, signal communication between said terminals is terminated.

2. The switch module of claim 1 wherein said terminals are socket connectors.

3. The switch module of claim 1 further comprising means for attaching said housing to a panel.

4. The switch module of claim 1 wherein said attaching means comprises a double sided adhesive member.

5. The switch module of claim 1 wherein said housing is in the shape of an octagon.

6. The switch module of claim 1 wherein said one side and said second sides are diametrically opposite sides.

7. The switch module of claim 3 wherein said attachment means is mounted to the back.

8. The switch module of claim 1 wherein said communication circuit is defined on a printed circuit board and said switch and said terminals are mounted to said circuit board.

9. The switch module of claim 1 wherein said housing is red.

10. A computer system comprising:
a computer having a service input port
a switch module mounted to said computer and comprising:
a housing having a front and back and multiple sides extending therebetween;
a pair of service line terminals disposed at one side;
a switch having an actuator disposed at a second side; and
a communication circuit disposed in said housing and extending from said terminals to said switch;
a cable connecting one of said terminals and said input port;
a service line connecting said other terminal, wherein when said actuator is in a first position, a signal on said service line communicates with said computer and when said actuator is in a second position, signal communication to said computer is terminated.

11. The system of claim 10 wherein said terminals are socket connectors.

12. The system of claim 10 wherein said module is mounted to said computer by a double sided adhesive member.

13. The system of claim 10 wherein said housing is in the shape of a regular octagon.

14. The system of claim 10 wherein said one side and said second sides are diametrically opposite sides.

15. The system of claim 10 wherein said module is mounted to the computer at the module back.

16. The system of claim 10 wherein said communication circuit is defined on a printed circuit board and said switch and said terminals are mounted to said circuit board.

17. The system of claim 10 wherein said switch is double pole, single throw, rocker switch.
